(19) United States
(12) Patent Application Publication
(10) Pub. No.: US 2016/0291854 A1
(43) Pub. Date: Oct. 6, 2016

(54) METHODS AND SYSTEMS FOR CONFIGURATION OF A VEHICLE FEATURE

(71) Applicant: FORD MOTOR COMPANY OF AUSTRALIA LIMITED, Victoria (AU)

(72) Inventor: Luke ADDATI, Victoria (AU)

(21) Appl. No.: 14/672,772

(22) Filed: Mar. 30, 2015

(51) Int. Cl. G06F 3/0484; H04L 29/08; G06F 3/0482

(52) U.S. Cl. CPC G06F 3/04847; G06F 3/0482; G06F 3/04842; H04L 67/125

(57) ABSTRACT

A vehicle includes an interface and a processor programmed to prompt a user to configure a series of configurable features. The processor may be further programmed to sequentially output via the interface the series of configurable features based on a configuration request. The series of configurable features each prompting the user to select one of a plurality of options associated with the configurable feature to capture a preference of the user for the configurable feature. The processor may be further programmed to alter settings associated with the configurable features based on the selection of the options via the user interface.

### TECHNICAL FIELD

The present disclosure relates to a step-by-step interactive instruction for configuration of a vehicle feature.

### BACKGROUND

Conventional manuals for operating features and/or functions of a vehicle are provided in the form of printed operating instructions and quick-reference guides. In the operating instructions, all information is clearly summarized and explained in detail as in a reference book. In the quick-reference guide, a feature is explained at a high level so that a user may understand the basic functionality of the feature. The operating features and/or functions of the vehicle are becoming increasingly extensive and complex due to the growing use of electronics. The operating instructions may be lengthy and hard to guide through. As a result, a user may not make use of the operating instructions which would explain how to configure the features and/or functions that are included in the vehicle. If a user does not configure the features and/or functions of the vehicle, a vehicle computing system may set the features and/or functions to a default setting or put them in a disabled state. Therefore, the user may not fully appreciate the features and functions that are offered in the vehicle based on the lack of being able to configure the features and/or functions to a user's preference.

### SUMMARY

A vehicle includes an interface and a processor programmed to prompt a user to configure a series of configurable features. The processor may be further programmed to sequentially output via the interface the series of configurable features based on a configuration request. The series of configurable features each prompting the user to select one of a plurality of options associated with the configurable feature to capture a preference of the user for the configurable feature. The processor may be further programmed to alter settings associated with the configurable features based on the selection of the options.

A device includes a processor programmed to prompt a user to configure a series of configurable features. The processor may be further programmed to sequentially output the series of configurable features based on a vehicle configuration request. The series of configurable features each prompting the user to select one of a plurality of options associated with the configurable feature to capture a preference of the user for the configurable feature. The processor may be further programmed to transmit a signal, via a communication connection with a vehicle processor, to alter settings for the configurable features based on the selection of the options.

A configuration method includes an interface in communication with a vehicle processor for prompting a user to configure a series of configurable features. The method may execute, via the vehicle processor, a configuration request for sequentially outputting at the interface a series of configurable features. The series of configurable features each prompting a user to select one of a plurality of options associated with the configurable feature to capture a preference of the user for the configurable feature. The method may alter settings associated with the configurable features based on the selection of the options at the user interface.

### BRIEF DESCRIPTION OF THE DRAWINGS

FIG. 1 is an exemplary block topology of a vehicle infotainment system implementing a user-interactive vehicle information display system;

FIG. 2 illustrates an exemplary configuration system;

FIG. 3 illustrates an exemplary configuration system presenting configuration mode options at a display;

FIG. 4 illustrates an exemplary user interface of the configuration system from which settings for a navigation system are displayed;

FIG. 5 illustrates an exemplary user interface of the configuration system providing settings for a navigation system feature;

FIG. 6 illustrates the exemplary configuration system presenting configuration options at the display as shown in FIG. 3;

FIG. 7 illustrates an exemplary user interface of the configuration system from which settings for the drive away locking feature are displayed; and

FIG. 8 illustrates an exemplary method for the configuration mode system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

The disclosure relates to systems and methods for providing a configuration mode allowing a vehicle user to scroll through all the features available at a vehicle. The configuration mode may enable the vehicle user to customize a feature before the mode continues to scroll to the next available feature. The systems and methods may assist in configuring the available features and/or functions (herein known as features) of a vehicle computing system based on the preference of the vehicle user. For example, when the user purchases a vehicle the one or more features may be set to a default value or may be disabled depending on the feature. The configuration mode may describe the feature while allowing the user to format one or more settings for the feature.

In one example, the “follow me home light time” feature (herein known as light time feature) is a vehicle feature that allows the exterior lights of the vehicle to stay on for a predefined amount of time after the vehicle ignition has been set to a key-off position. The light time feature provides light via the exterior lights to assist a user navigating outside the vehicle through the dark for an amount of time before the exterior lights are disabled. The configuration mode may explain the light time feature to a user and allow the user to set the predefined amount of time to enable the lights once the key-off position is detected. For example, a user may live in a rural area and would prefer the exterior lights of the vehicle to stay on for a period of time after a key-off event to assist the user in navigating to the door of their home at night.

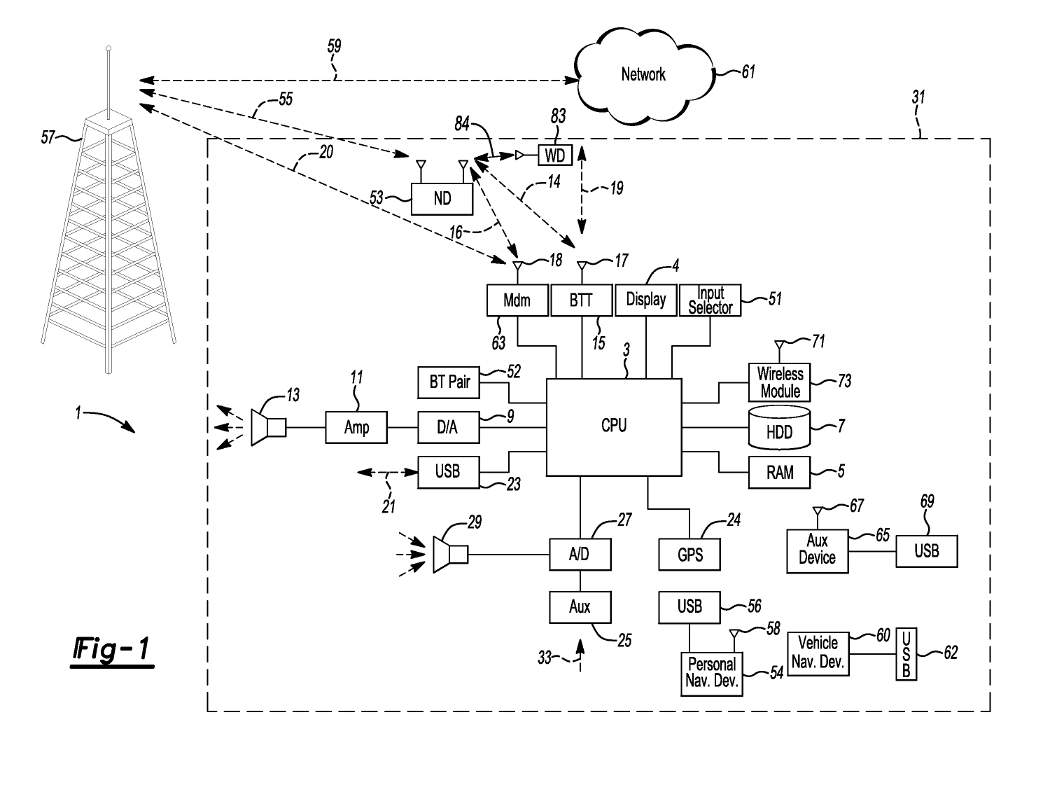

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 and/or a HUD (not shown) located in the vehicle. The user may also be able to interact with the interface if it is provided, for example, with a touch sensitive screen. In another illustrative embodiment, the interaction occurs through button presses, and/or a spoken dialog system with automatic speech recognition and speech synthesis.

In the illustrative embodiment shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

For example, the configuration mode may receive one or more feature settings from various vehicle components and/or auxiliary components in communication with the VCS via the vehicle network. The configuration mode may receive input to configure the one or more feature settings for the various components. The configuration mode may transmit the configured one or more feature settings to the respective components via the vehicle network.

Outputs to the system may include, but are not limited to, the visual display 4, the HUD, and a speaker 13 or stereo system output. The speaker 13 is connected to an amplifier 11 and receives its signal from the processor 3 through a digital-to-analog converter 9. Outputs can also be made to a remote BLUETOOTH device such as PND 54 or a USB device such as vehicle navigation device 60 along the bi-directional data streams shown at 19 and 21 respectively.

For example, the configuration mode may be presented to the handheld device in communication with the VCS via a BLUETOOTH connection. The handheld device may receive input to configure the one or more feature settings. The handheld device may transmit the feature settings to the VCS via the BLUETOOTH connection.

In one illustrative embodiment, the system 1 uses the BLUETOOTH transceiver 15 to communicate 17 with a user's handheld device 53 (e.g., cell phone, smart phone, PDA, or any other handheld device having wireless remote network connectivity). The handheld device 53 can then be used to communicate 59 with a network 61 outside the vehicle 31 through, for example, communication 55 with a cellular tower 57. In some embodiments, tower 57 may be a WiFi access point.

Exemplary communication between the handheld device 53 and the BLUETOOTH transceiver is represented by signal 14.

Pairing a handheld device 53 and the BLUETOOTH transceiver 15 can be instructed through a button 52 or similar input. Accordingly, the CPU is instructed that the onboard BLUETOOTH transceiver will be paired with a BLUETOOTH transceiver in a handheld device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The handheld device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a handheld device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the handheld device 53 includes a modem for voice band or broadband data communication. In the data-over-voice embodiment, a technique known as frequency division multiplexing may be implemented when the owner of the handheld device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, handheld device 53 is replaced with a cellular communication device (not shown) that is installed to vehicle 31. In yet another embodiment, the handheld device 53 may be a wireless local area network (LAN) device capable of communication over, for example (and without limitation), an 802.11g network (i.e., WiFi) or a WiMax network.

In one embodiment, incoming data can be passed through the handheld device 53 via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication. The system 1 may communicate the data received from the handheld device and/or the additional sources to one or more outputs. The one or more outputs may include, but is not limited to, the display 4, speaker 29, HUD (not shown), and/or a combination thereof.

Further, the CPU could be in communication with a variety of other auxiliary devices 65. These devices can be connected through a wireless 67 or wired 69 connections. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, the handheld device (e.g., and without limitation, a mobile phone) or a remote computing system (e.g., and without limitation, a server) connected through the handheld device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired handheld device, then it is likely that the handheld device is not performing the process, since the handheld device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

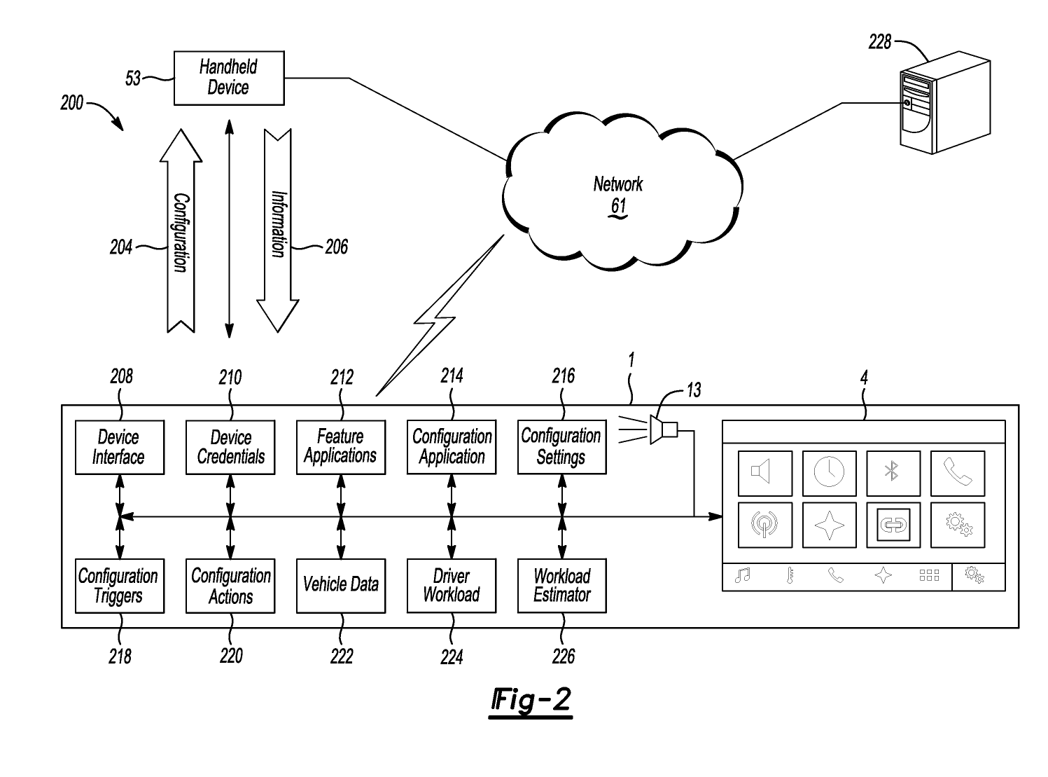

FIG. 2 illustrates an exemplary configuration system 200. As illustrated, the system 200 may include the handheld device 53 connected to the VCS using a short range wireless connection or through the network 61. The system 200 further includes a device interface 208 of the VCS 1 configured to access the handheld device 53 according to security credentials 210, send devices commands 204 to the handheld device 53, and receive information 206 from the handheld device 53. In another embodiment, the handheld device 53 may communicate with the VCS 1 via the network 61.

The system 200 also includes feature applications 212 configured to utilize the device interface 208 to control and/or configure one or more vehicle features at the VCS 1 according to user input at the user interface and/or the handheld device 53. The system 200 may use a configuration mode application 214 configured to utilize the device interface 208 to communicate with the handheld device 53 according to configuration settings 216 of the one or more vehicle features. Each configuration setting 216 may be associated with one or more configuration triggers 218 and one or more configuration actions 220.

For example, in response to a configuration mode request, the VCS 1 may scroll through settings for a handheld device feature via the configuration mode application 212 at the user interface display 4. The configuration settings 216 for the handheld device feature may include pairing of a handheld device 53. In another example, the VCS 1 may transmit one or more vehicle feature settings to a handheld device 53 in communication with the VCS 1. The handheld device 53 may receive configuration settings from the VCS 1 via the device interface 208 and credentials 210. The handheld device may receive input to select one or more configuration settings 216 for a feature via the configuration mode application 212. The handheld device may transmit the selected one or more configuration settings 216 to the VCS 1.

The system 200 further includes a workload estimator 226 configured to receive vehicle data 222 and determine driver workload 224. The driver workload 224 may measure if the vehicle is in an acceptable condition to launch the configuration mode based on the vehicle data 222. The vehicle data may include, but is not limited to, transmission gear, vehicle speed, and/or a combination thereof. For example, the system 200 may exit out of the configuration mode if a driver workload 224 exceeds a threshold value.

The system 200 may also include a configuration server 228 programmed to facilitate configuration of the features at the VCS 1 using the device interface 208 and device credentials 210. It should be noted that the illustrated system 200 is merely exemplary, and more, fewer, and/or differently located elements may be used. As one example, the system 200 may utilize a data connection of the handheld device 53 to facilitate the communication between the VCS 1 and the configuration server 228. The configuration server 228 may store one or more configuration settings 216 for a feature application 212 based on an identified user and/or vehicle.

The handheld device 53 may include various types of devices that perform useful functions and communicates with the VCS 1. The device commands 204 may include messages configured to control functions and/or settings of the VCS 1 via the handheld device 53. As illustrated, the handheld device 53 may be configured to communicate the configuration commands 204 206 over the network 61 to the VCS 1. As some other examples, the handheld device 53 may be configured to receive the VCS 1 commands 204 over other networks or types of network connection, such as over a BLUETOOTH connection, over a ZIGBEE wireless mesh network, or over another suitable type of network or network protocol for providing wireless device commands 204. The handheld device commands 204 may be configured to cause the handheld device to set one or more feature settings for the VCS 1 based on the configuration mode being enabled, such as lock or unlock doors via drive away locking, enable light time feature, configure an emergency contact list, and enable or disable motion sensor sensitivity functionality. The command responses 206 may include messages configured to transmit selected feature options for the one or more feature settings over to the VCS 1. In some cases, the device commands 204 may be configured to request status information regarding the handheld device 53 connection (e.g., whether a user is able to communicate with the VCS 1 using the handheld device 53), and the command responses 206 may be configured to return the requested status information back to the requester.

The device interface 208 may be configured to provide the handheld device 53 and/or the configuration server 228 with access to the one or more vehicle features at the VCS 1. To provide the access, the device interface 208 may be configured to expose an API allowing other applications of the VCS 1 to provide configuration commands 204 to the handheld device 53 and receive command responses 206 configuring one or more feature settings from the handheld device 53 responsive to the provided feature configuration commands 204. For example, in response to an Emergency 911 application configuration via the configuration mode application, a contact list configuration may be sent to the handheld device 53 from the VCS 1 so that a user may provide one or more contacts for configuration of the application.

The VCS 1 may be configured to require security credentials 210 to allow a handheld device 53 and/or the configuration server 228 to communicate configuration communication 204 206 to the handheld device 53. As some examples, the handheld device 53 and/or configuration server 228 may require an account name or username, and a password, passphrase, personal identification number, fingerprint, or other credential that may be used to ensure that the requesting user is authorized to access the vehicle features at the VCS 1. The VCS 1 may be configured to maintain and provide the security credentials 210 for the handheld device 53 and/or configuration server 228 to facilitate the connection and command execution using the device interface 208. In some cases, the device interface 208 maybe further configured to maintain information regarding the handheld device 53 that may be configurable by the device interface 208. For example, the device interface 208 may expose API information related to the handheld device 53 for which security credentials 210 are available, as well as information regarding the capabilities of the connected handheld device 53 (e.g., based on the model of handheld device 53, based on a query of the handheld device 53 by the device interface 208 for capability information).

The feature applications 212 may include one or more applications installed at the VCS 1 and configured to make use of functionality of the one or more features available on the vehicle. As an example, the feature applications 212 may include a Bluetooth configuration application 212 configured to allow a handheld device 53 to be configured to communicate with the VCS 1. As another example, the feature applications 212 may include a navigation configuration application 212 to allow the user to configure one or more navigation settings (toll roads preference, for example).

The configuration mode application 214 may be another example of a feature application 212, and may be configured to allow a user to scroll through one or more feature settings for the features/functions of the VCS 1. The configuration mode application 214 may include functionality to determine when specified trigger conditions 218 have occurred, and to perform specified actions 220 in response to triggering of the trigger conditions 218. These triggers and actions may be referred to herein as configuration settings 216.

The vehicle data 222 may include various inputs that may be monitored by the VCS 1 to receive indications of the vehicle 31 status. Exemplary vehicle data 222 may include, for example, global position coordinates, speed, yaw, pitch, roll, lateral acceleration, temperature, and rain sensor inputs, as some possibilities. In some cases, the vehicle data 222 may include elements of data made available via the vehicle bus (e.g., via the controller area network (CAN)). In other cases, the vehicle data 222 may include elements of data that may be otherwise received from vehicle 31 sensors and systems (e.g., yaw information received from a stability system, rain sense information received from a weather detection system, etc., location information received from a positioning system, etc.). In yet further cases, the vehicle data 222 may include other information obtained from a connected mobile device (from handheld device 53 over Bluetooth, WiFi, etc., for example).

The trigger conditions 218 of the configuration settings 216 may be defined according to a relationship of one or more elements of vehicle data 222 to one or more predefined conditions. For example, in response to a request to enter a configuration mode, the information may be output by the system based on a trigger condition 218. The trigger condition may be configured to define a relationship of vehicle speed, such as to define a condition that is triggered when the vehicle 31 is below a predefined speed (e.g., driving less than zero miles per hour) and/or the powertrain gear selection, (e.g., the powertrain is in a PARK gear) before enabling the configuration mode for the VCS 1.

The actions 220 of the configuration settings 216 may be defined according to an available feature of the VCS 1. As an example, during the configuration mode, an action 220 may include sending a configuration command 204 to a connected handheld device 53 to configure an emergency contact list, remedial actions, and/or a combination thereof for the Emergency 911 application 212. As another example, during the configuration mode, the action 220 may include sending a configuration command 204 to the configuration server 228 to receive one or more vehicle feature settings for the VCS 1 based on an identified user, vehicle, and/or combination thereof.

The configuration mode application 214 may further include messages to a user interface 4 for facilitating the configuration of the configuration settings 216, without requiring the user to navigate separate feature applications 212 to select settings for each vehicle feature. Further aspects of the user interface 4 of the configuration mode application 214 are discussed in detail below.

In some cases, the user interface 4 of the configuration mode application 214 may be made available to the user only when driver workload 224 permits the user to invoke the configuration mode user interface. For example, the workload estimator 226 may be configured to receive the vehicle data 222 (e.g., via the CAN bus, from the vehicle systems or sensors, etc.) and identify a driver workload 224 based on the received vehicle data 222. In one possible approach, the workload estimator 226 may be configured to utilize a set of rules to determine a driving situation from the vehicle data 222, and to further determine the driver workload 224 according to the driving situation. More specifically, based on the received vehicle data 222, the workload estimator 226 may be configured to match the received vehicle data 222 against one or more conditions specified by the rules where each rule may be defined to indicate a particular driving situation indication encountered by the vehicle 31 when the conditions of the rule are satisfied. As some examples, rules may define a high traffic density condition according to criteria identifying many stops and starts in brake, accelerator or speed vehicle data 222, a merge condition according to vehicle data 222 indicative of a swerve maneuver at speed, and/or a parked condition according to a park vehicle gear selection indicated in the vehicle data 222, etc. Moreover, each driving situation may be associated with a corresponding driver workload 224 (parked vehicle situations associated with a low-level driver workload 224, merge situations associated with a mid-level driver workload 224, high traffic density associated with a high-level driver workload 224, for example). As another example, the workload estimator 226 may associate certain conditions such as extreme weather with heightened driving demand, such that, as one possibility, the workload estimator 226 may associate certain weather conditions combined with a mid-level demand area (a merge situation, for example) with a heightened workload estimation, such as a high-level driver workload 224. The driver workload 224 may include information indicating a relative level of current driver workload, such as by a value along a scale (from 1 to 5, from 0.01 to 1.00, etc., for example).

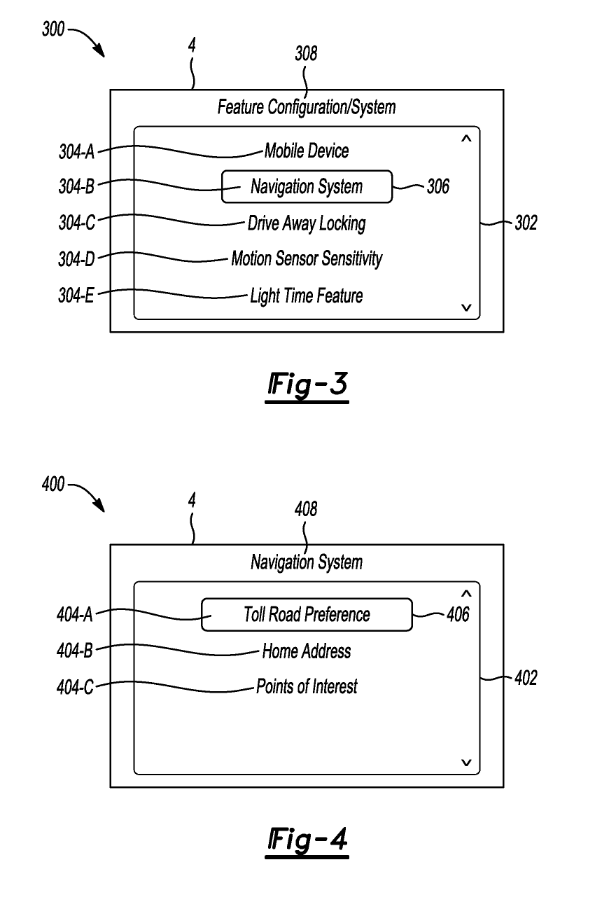

The configuration server 228 may be a server device configured to facilitate configuration of the configuration settings 216 through a user interface that is available outside of the vehicle 31 and regardless of driver workload 224. In an example, the configuration server 228 may be configured to provide a web-based front end user interface (one or more web pages, for example) or data for use by a thick-client user interface, allowing for the selection of configuration settings 216, such as trigger conditions and actions to be performed by the vehicle 31 resulting from occurrence of the trigger conditions. To perform the configuration, the configuration server 228 may be programmed to receive the configuration mode application 214 from the vehicle 31, provide a user interface through which the configuration settings 216 may be updated based on execution of the configuration mode application, and provide the updated configuration settings back to the vehicle 31 for use by the one or more vehicle features. Further details of the integration of the configuration mode into the vehicle 31 system are discussed in detail below with respect to FIGS. 3-8.

FIG. 3 illustrates an exemplary configuration system presenting configuration mode options at a display. The user interface 300 may be presented at the touchscreen display 4 and/or at a handheld device 53 display, and may include a list control 302 configured to display selectable list entries 304-A through 304-E (collectively 304) of the configuration mode application for one or more vehicle features. The configuration mode may scroll through each of the selectable list entries 304 while providing a verbal and/or text explanation of each feature using the display 4, over the speaker 13 or stereo system output, and/or a combination thereof.

For example, in response to the configuration mode application being enabled, the VCS 1 may present the selectable list entries 304 at the display 4. The configuration mode may highlight each entry 304 while giving a short explanation of each feature listed as an entry. In another example, the VCS 1 may transmit the configuration messages to a connected handheld device 53 so that the selectable list entries 304 may be displayed at the device 53.

The configuration mode application 212 may be available on the handheld device 53 to receive user input for configuring one or more settings for a vehicle feature. The handheld device 53 may communicate to the VCS 1 via a wired and/or wireless connection. For example, the user interface 300 and the other user interfaces discussed herein may be displayed elsewhere, such as by way of a connected application executed by the VCS 1 via a paired connection with the handheld device 53. The user interface 300 may also include a title label 308 to indicate to the user that the user interface 300 is utilizing the connected application of the VCS 1.

As illustrated, the selectable list 302 of the configuration mode application includes an entry 304-A for a mobile device configuration, an entry 304-B for a navigation system configuration, and an entry 304-C for a drive away locking configuration. The list control 302 may operate as a menu, such that a user of the user interface 300 may be able to scroll through list entries of the list control 302 (using up and down arrow buttons and a select button to invoke the selected menu item 306, for example). In some cases, the list control 302 may be displayed on a user interface screen of the handheld device 53, such that the user may be able to touch the list control 302 to select and invoke a menu item. For example, when the entry 304-C for the drive away locking configuration is selected, the handheld device 53 may provide a display and an explanation for the feature to enable a user to configure the settings for the drive away locking configuration.

The configuration mode application may respond to a selected entry 304 and provide a verbal and/or text explanation for the one or more settings related to the selected entry 304. For example, when the entry 304-B for the navigation system configuration is selected 306, the VCS may provide an explanation of the one or more feature settings for the navigation system.

The list control 302 may include additional entries. For example, an entry 304-D for a motion sensor sensitivity configuration may be configured to cause an alarm to trigger when motion is detected inside a vehicle cabin. As another example, the “Light Time Feature” entry 304-E, when invoked, may be configured to cause the exterior lights of the vehicle to stay on for a predefined amount of time after the vehicle ignition has been set to a key-off position.

In another embodiment, the handheld device 53 may execute the configuration mode application. The configuration mode application at the handheld device 53 may receive input to determine the one or more features available for a particular vehicle. For example, the configuration mode application may receive a vehicle identification number, a unique identifier, user identification, and/or combination thereof to determine which vehicle features are available for the vehicle.

In one example, the handheld device 53 may be in communication with the configuration server 228 to identify and receive the one or more vehicle features available for the vehicle based on the vehicle identification number. In response to the vehicle identification number, the configuration mode application may identify one or more available features for the vehicle. The configuration mode application may provide a tutorial of the features available for the identified vehicle at the handheld device 53. During the tutorial, the configuration mode application may receive input via the handheld device user interface to configure settings for the one or more available features. Once the configuration mode application has received input to configure the settings for the one or more available features, the handheld device may transmit the one or more settings to the VCS 1 and/or the configuration server 228. For example, the handheld device 53 may be brought to the vehicle to communicate the configured one or more settings to the VCS 1 using wireless technology. The VCS 1 may output a message requesting confirmation from the user to accept the one or more settings from the configuration mode application executed at the handheld device 53.

The VCS 1 may receive one or more settings that have been configured based on the configuration mode application being executed at the handheld device 53 using the device interface 208. The VCS 1 may enable communication with the handheld device 53 via the device credentials 210. The configuration mode application 214 may be executed at the VCS 1 and configured to enable the use of hardware and/or software applications at the handheld device 53 via the device interface 208.

For example, the VCS 1 may receive a configuration of the one or more vehicle feature settings from the nomadic device 53. The configuration mode may be executed at the VCS 1 via the configuration mode application 214. The VCS 1 may output one or more vehicle feature settings for configuration at the display 4 based on the configuration mode application 214. The VCS 1 may begin executing the configuration mode tutorial based on the configuration mode application 214. The configuration mode application 214 may receive one or more configuration trigger conditions 218 from the handheld device 53. The handheld device 53 may provide a user interface to allow the configuration of the configuration trigger conditions 218. The trigger conditions 218 may be configured under the “Motion Sensor Sensitivity” entry 404-D. For example, the motion sensor sensitivity may be configured to set an alarm based on one or more trigger conditions including, but not limited to, a motion detector inside the vehicle cabin, vehicle seat sensors, and/or a combination thereof. In another example, the trigger conditions 218 may be configured at the VCS 1. In response to the execution of the configuration mode application 214, the VCS 1 may transmit the one or more feature settings to the handheld device 53 and/or the configuration server 228 for storage.

FIG. 4 illustrates an exemplary user interface of the configuration system from which settings for a navigation system are displayed via the configuration mode application. As with the user interface 300, the user interface 400 may also be presented at a display via the handheld device 53 and/or VCS 1. The user interface 400 may include a list control 402 configured to display a selectable list of entries, where each entry is associated with a corresponding application command 404-A through 404-D (collectively 404). Each of the commands 404 may indicate a feature available for use by the VCS 1. The user interface 400 may also include a title label 408 to indicate to the user that the user interface 400 is the navigation system settings for the navigation system (as invoked via selection 306 of the entry 304-B from the user interface 300, for example).

With respect to the commands 404 of the list control 402, as one example, the list control 402 may include a command 404-A that, when invoked, is configured to receive toll road preference settings. As another example, the list control 402 may include a command 404-B that, when invoked, is configured to cause the VCS 1 to receive home address information to provide the VCS a home destination that may be stored via software and hardware at the VCS. As a further example, the list control 402 may include a command 404-C that, when invoked, is configured to cause the VCS 1 to receive points of interest that a user may find useful when driving. The points of interests may be based on one or more trigger conditions. For example, a point of interest could be a preferred coffee shop, and may be presented to the user based on a predefined time trigger condition, predefined location trigger condition, and/or a combination thereof.

The VCS 1 may receive navigation system settings 408 from the handheld device 53 for output at the vehicle display 4 via a communication link. A user may be able to configure the toll road preference when command 404-A is invoked at the handheld device 53. For example, the toll road preference may be configured to select whether the driver is willing to take toll roads. The navigation system settings 408 may be configured at the handheld device 53 and transmitted to the VCS 1 once a communication link has been established therebetween.

As with the list control 302, the list control 402 may also operate as a menu, such that a user of the user interface 400 may be able to scroll through list entries of the list control 402 (using up and down arrow buttons and a select button to invoke the selected menu item 406). Upon touch or button selection of one of the commands 404, the handheld device 53, VCS 1 and a combination thereof may be configured to perform the selected action.

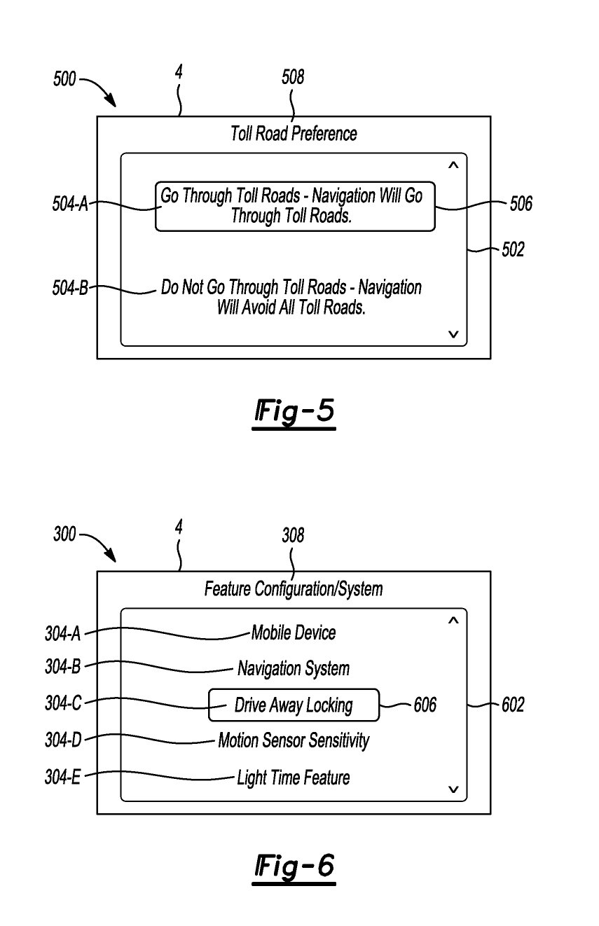

FIG. 5 illustrates an exemplary user interface of the configuration system providing settings for a navigation system feature via the configuration mode application. The user interface 500 may be presented in the vehicle 31 via the display 4, and may include a list control 502 configured to display selectable list entries 504-A through 504-B (collectively 504) of the navigation system features that are available on the VCS 1 (or via a connected handheld device 53). The configuration mode application may give an explanation for the selectable list entries 504 to assist the user in configuring the one or more settings. In other examples, the user interface 500 and the other user interfaces discussed herein may be displayed elsewhere, such as by way of a connected application executed by a handheld device 53 paired with the VCS 1. The user interface 500 may also include a title label 508 to indicate to the user that the user interface 500 is for utilizing the configuration mode application of the handheld device 53, VCS 1, and/or a combination thereof.

As illustrated, the selectable list 502 of the configuration mode application customizing the navigation system includes an entry 504-A for selecting to go through toll roads, and an entry 504-B for selecting not to go through toll roads. In response to the selected toll road options, the navigation system may generate one or more routes based on whether the user's preference of toll roads. The list control 502 may operate as a menu, such that a user of the user interface 500 may be able to scroll through list entries of the list control 502 (e.g., using up and down arrow buttons and a select button to invoke the selected menu item 506). In some cases, the list control 502 may be displayed on a touch screen display 4, such that the user may be able to touch the list control 502 to select and invoke a setting menu item.

FIG. 6 illustrates the exemplary configuration system presenting configuration options at the display as shown in FIG. 3. The configuration mode may highlight each entry 304 while giving a short explanation of each feature listed as an entry. In this illustration, the configuration mode application has highlighted 606 entry 304-C and may provide the configuration information about the drive away locking feature.

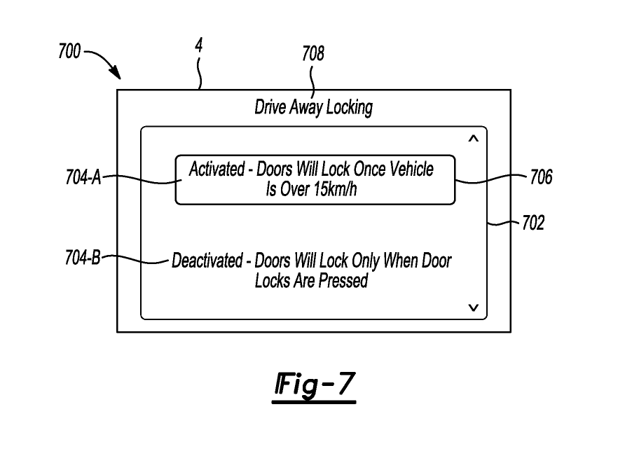

For example, the configuration mode application may output an explanation of the drive away locking feature 304-C. The configuration mode may select entry 304-C and output for display the one or more settings for the drive away locking feature as shown in FIG. 7.

FIG. 7 illustrates an exemplary user interface of the configuration system from which settings for the drive away locking feature are displayed via the configuration mode application. The configuration mode application may scroll through the drive away locking feature user interface display. As with the user interface 300, the user interface 700 may also be presented at a display via the handheld device 53 and/or VCS 1. The user interface 700 may include a list control 702 configured to display a selectable list of entries, where each entry is associated with a corresponding application command 704-A through 704-B (collectively 704). Each of the commands 704 may indicate a feature setting available for use by the VCS 1. The user interface 700 may also include a title label 708 to indicate to the user that the user interface 700 is the drive away locking settings for the VCS 1 (as invoked via selection 606 of the entry 304-C from the user interface 300, for example).

The configuration mode application may provide an explanation for each entries 704 listed in the user interface 700. In one embodiment, the configuration mode application may not provide an explanation, however, may present the entries 704 available and allow a user to select one or more settings within a predefined amount of time. If a selection is made, the configuration mode may scroll to the next feature for configuration. If a selection is not made within the predefined amount of time for the setting, the configuration mode application may skip the setting(s) and scroll to the next feature to display for the user.

The drive away locking feature may configure a setting to activate locking the doors based on one or more trigger events if the entry 704-A is selected. The drive away locking feature may configure a setting to deactivate the automatic locking of the doors if the entry 704-B is selected. The configuration mode may scroll through each entry 704 while providing an explanation for the feature setting. The configuration mode application may enable a user to select 706 an entry for configuring the vehicle feature. In response to the selected entry 706, the configuration mode may store that setting and scroll to the next feature that may be configured.

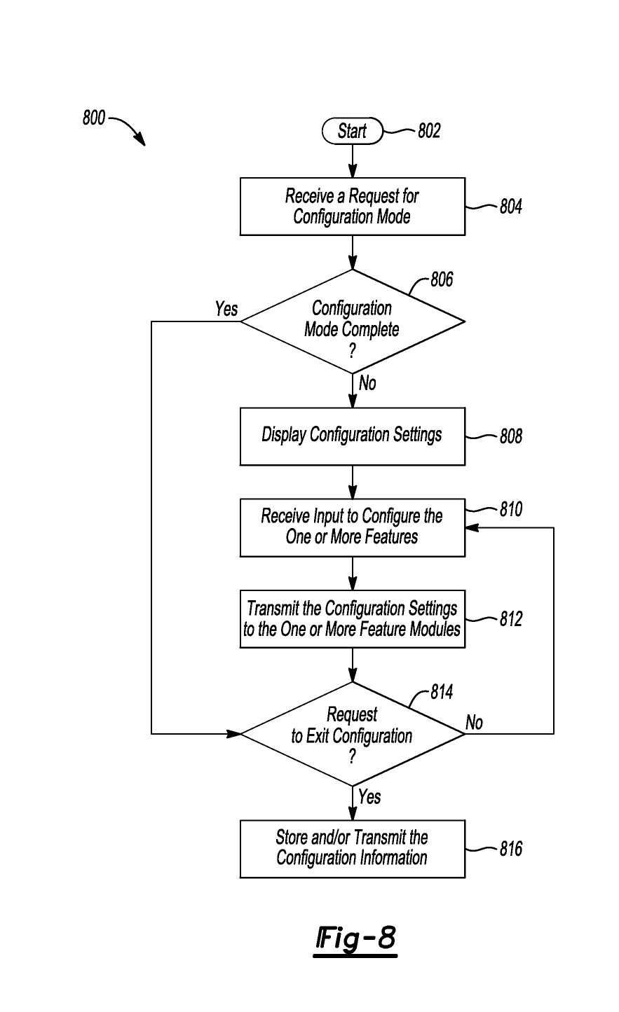

FIG. 8 illustrates an exemplary method 800 for the configuration mode system. The method 800 may be implemented using software code contained within the VCS 1, the handheld device 53, and/or a combination thereof. In other embodiments, the process 800 may be implemented in other vehicle controllers, or distributed among multiple controllers in communication with the VCS 1.

Referring again to FIG. 8, the vehicle 31 and its components illustrated in FIG. 1 through FIG. 7 are referenced throughout the discussion of the method to facilitate understanding of various aspects of the present disclosure. The method 800 of configuring one or more vehicle features may be implemented through a computer algorithm, machine executable code, or software instructions programmed into a suitable programmable logic device(s) of the vehicle, such as the vehicle control module, the handheld device control module, another controller in communication with the vehicle computing system, or a combination thereof. Although the various operations shown in the flowchart diagram 800 appear to occur in a chronological sequence, at least some of the operations may occur in a different order, and some operations may be performed concurrently or not at all.

In operation 802, the one or more controllers executing the configuration mode application may be initialized based on a power on request. For example, a VCS 1 may be initialized based on a key-on request. The configuration mode application may be executed based on a request to enable the application via input at a user interface. In another example, the configuration mode application may be executed based on a CAN message received using a communication toll via the diagnostic link connector. For example, if a customer purchases a vehicle from a dealership, a technician may send a message to the VCS 1 to begin the configuration mode at the next key cycle so that the customer may go through the features offered for the vehicle and configure the vehicle to suit the customer. In another embodiment, the configuration mode application may be initiated based on a wireless message sent by a remote server and received at the VCS 1.

In operation 806, before executing the configuration mode application, the VCS 1 may determine if the configuration has already been complete. For example, the VCS 1 may communicate with a remote server to receive one or more vehicle feature settings configured by the customer. In another embodiment, the VCS 1 may receive one or more vehicle settings configured via the configuration mode application executed at a connected handheld device 53.

In operation 808, the configuration mode application may display one or more configuration settings by scrolling through the vehicle features available for the vehicle. The configuration mode application may receive input to configure the one or more features in operation 810.

In operation 812, the configuration mode application may transmit the selected feature settings to the one or more feature modules in communication with the VCS 1. In one embodiment, if the configuration mode application is being executed at the handheld device, the application may store the one or more feature settings until the device can transmit the settings to the VCS 1 upon a communication connection therebetween. In another embodiment, the configuration mode application may transmit the selected feature settings to the configuration server for storage. The configuration server may communicate the selected feature settings to the VCS 1.

In operation 814, the configuration mode application may be requested to exit based on the completion of configuring the one or more feature settings and/or a request to exit the application by a user. Upon a request to exit the configuration mode application, the application may store the configuration information and/or transmit the configuration information to the VCS 1 in operation 816.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an interface; and
a processor programmed to,
in response to a configuration request, sequentially output via the interface a series of configurable features each prompting a user to select one of a plurality of options associated with the configurable feature to capture a preference of the user for the configurable feature, and
in response to selection via the interface of the options, alter settings associated with the configurable features.

2. The vehicle of claim 1, wherein the processor is further programmed to establish communication, via a wireless transceiver, with a handheld device configured to execute at least one feature from the configurable features, and transmit a signal to alter settings associated with the at least one feature executed at the handheld device.

3. The vehicle of claim 1, wherein the processor is further programmed to establish communication, via a wireless transceiver, with a network having a database, and transmit the altered settings associated with the configurable features to the database for storage.

4. The vehicle of claim 1, wherein the interface is a voice command receiver, a soft key, a hard key or a touch display screen.

5. The vehicle of claim 1, wherein the series of configurable features are vehicle features available for the vehicle.

6. The vehicle of claim 1, wherein the processor is further programmed to output each of the series of configurable features for no more than a predefined period of time.

7. The vehicle of claim 1, wherein the series of configurable features are associated with a mobile device connection, a navigation system, a drive-away locking feature, a motion sensor sensitivity feature, or a light time feature.

8. The vehicle of claim 7, wherein the plurality of options for the navigation system include a toll road preference, a home address entry, or a point of interest entry.

9. A device comprising:
a processor programmed to,
in response to a vehicle configuration request, sequentially output a series of configurable features each prompting a user to select one of a plurality of options associated with the configurable feature to capture a preference of the user for the configurable feature, and
in response to selection of the options, transmit a signal, via a communication connection with a vehicle processor, to alter settings for the configurable features.

10. The device of claim 9, wherein the processor is further programmed to establish communication with a network having a database and to transmit the altered settings to the database for storage.

11. The device of claim 9, wherein the processor is further programmed to output each of the series of configurable features for no more than a predefined period of time.

12. The device of claim 9, wherein the series of configurable features are associated with a mobile device connection, a navigation system, a drive-away locking feature, a motion sensor sensitivity feature, or a light time feature.

13. The device of claim 12, wherein the plurality of options for the drive-away locking feature include an activate automatic door lock option or a deactivate automatic door lock option.

14. A configuration method comprising:
executing, via a vehicle processor, a configuration request for sequentially outputting, via an interface in communication with the vehicle processor, a series of configurable features each prompting a user to select one of a plurality of options associated with the configurable feature to capture a preference of the user for the configurable feature; and
in response to selection via the interface of the options, altering settings associated with the configurable features.

15. The method of claim 14, further comprising establishing communication with a handheld device, via a wireless transceiver in communication with the vehicle processor, configured to execute at least one feature from the configurable features, and transmitting a signal to alter settings associated with the at least one feature executed at the handheld device.

16. The method of claim 14, further comprising establishing communication with a network having a database via a wireless transceiver in communication with the vehicle processor, and transmitting the altered settings to the database for storage.

17. The method of claim 14, wherein the series of configurable features are associated with a mobile device connection, a navigation system, a drive-away locking feature, a motion sensor sensitivity feature, or a light time feature

18. The method of claim 14, wherein the interface is a soft key, a hard key or an in-vehicle touch display screen.
